(19) United States
(12) Patent Application Publication
(10) Pub. No.: US 2015/0212643 A1
(43) Pub. Date: Jul. 30, 2015

(54) TOUCH SENSING CONTROLLER, TOUCH SENSING DEVICE AND TOUCH SENSING SYSTEM INCLUDING THE SAME

(71) Applicant: SAMSUNG ELECTRONICS CO., LTD., Suwon-si (KR)

(72) Inventors: JIN-CHUL LEE, Seoul (KR); KI-DUK KIM, Hwaseong-si (KR); HO-JIN PARK, Suwon-si (KR); YOON-KYUNG CHOI, Seoul (KR); MICHAEL CHOI, Seoul (KR); CHOONG-HOON LEE, Seoul (KR); SANG-HYUB KANG, Yongin-si (KR); KYUNG-HOON LEE, Seoul (KR)

(21) Appl. No.: 14/604,948

(22) Filed: Jan. 26, 2015

Related U.S. Application Data
(60) Provisional application No. 61/931,979, filed on Jan. 27, 2014.

(30) Foreign Application Priority Data
Nov. 28, 2014 (KR) 10-2014-0169180

(51) Int. Cl. G06F 3/041; G06F 3/044

(52) U.S. Cl. CPC G06F 3/0416; G06F 3/044

(57) ABSTRACT

A touch sensing device includes a touch panel and a receiving unit. The touch panel generates first to third receiving signals corresponding to a touch occurring at the touch sensing device. The receiving unit is connected to the touch panel through first to third receiving lines to receive the first to third receiving signals through the first to third receiving lines, respectively. The receiving unit includes a differential signal generator for excluding a first common signal common to the first and second receiving signals from each of the first and second receiving signals to generate first differential signals when a first touch sensing operation is performed. The differential signal generator excludes a second common signal common to the second and third receiving signals from each of the second and third receiving signals to generate second differential signals when a second touch sensing operation is performed.

### CROSS-REFERENCE TO RELATED APPLICATIONS

This application claims priority under 35 U.S.C. §119(e) to U.S. Provisional Application No. 61/931,979, filed on Jan. 27, 2014, in the United States Patent and Trademark Office, and under 35 U.S.C. §119(a) to Korean Patent Application No. 10-2014-0169180, filed on Nov. 28, 2014, in the Korean Intellectual Property Office, the disclosures of which are incorporated by reference herein in their entireties.

### TECHNICAL FIELD

The present inventive concept relates to a touch sensing controller, a touch sensing device and a touch sensing system including the same, and more particularly, to a touch sensing controller capable of increasing sensing sensitivity, a touch sensing device and a touch sensing system including the same.

### DISCUSSION OF THE RELATED ART

A touch screen panel is a device through which a user's command is input by a finger touch or a touch pen. The touch screen panel may be applied to various display devices. In a capacitance-type touch screen panel, when a touch occurs at the touch screen panel, capacitance values near to where the touch occurs may vary to sense an occurrence and a position of the touch.

### SUMMARY

According to an exemplary of the present inventive concept, there is provided a touch sensing device. The touch sensing device includes a touch panel and a receiving unit. Touch panel is configured to generate a first receiving signal, a second receiving signal, and a third receiving signal corresponding to a touch occurring at the touch sensing device. The receiving unit is connected to the touch panel through a first receiving line, a second receiving line, and a third receiving line. The receiving unit receives the first receiving signal, the second receiving signal, and the third receiving signal through the first receiving line, the second receiving line, and the third receiving line, respectively. The receiving unit further includes a differential signal generator for excluding a first common signal common to the first receiving signal and the second receiving signal from each of the first receiving signal and the second receiving signal to generate first differential signals when a first touch sensing operation is performed. The differential signal generator excludes a second common signal common to the second receiving signal and the third receiving signal from each of the second receiving signal and the third receiving signal to generate second differential signals when a second touch sensing operation is performed.

The first and second differential signals may include a first noise component caused by a voltage applied to a display panel adjacent to the touch panel. The receiving unit may further include a charge integrator including a demodulator and a charge amplifier. The demodulator may convert the first noise component into a second noise component having a higher frequency than that of the first noise component. The charge amplifier may include a low pass filter to filter the second noise component.

The demodulator may convert the first and second differential signals excluding the first noise component into direct current (DC) component signals having a uniform level. The charge amplifier may integrate charges corresponding to the DC component signals.

The differential signal generator may include a first node and a second node to which input voltages corresponding to the first through third receiving signals are selectively applied. The differential signal generator may further include a common mode amplifier to which a common voltage for excluding one of the first common signal or the second common signal is applied.

The differential signal generator may include a switching block. The switching block may include a plurality of switching units for selectively connecting two receiving lines among the first receiving line, the second receiving line, and the third receiving line to the common mode amplifier.

The common mode amplifier may convert the input voltages into the common voltage and may maintain the common voltage.

The common voltage may be a voltage having a uniform level in a mutual capacitance sensing mode and may be a voltage having a square pulse shape in a self-capacitance sensing mode.

The common mode amplifier may include an input unit, an amplifying unit, and an output unit. The input unit may selectively provide a current to an amplifying unit based on information on magnitudes of the input voltages and the common voltage. The amplifying unit may amplify the current provided from the input unit. The output unit may output an output signal for excluding one of the first common signal or the second common signal.

According to an exemplary embodiment of the present inventive concept, there is provided a touch sensing system. The touch sensing system includes a transmitting unit, a receiving unit, and a touch sensing controller. The transmitting unit is connected to the driving lines in the touch panel to provide driving signals. The receiving unit includes a differential signal generator connected to receiving lines in the touch panel to respectively receive receiving signals generated by the driving signals. The receiving unit generates generate differential signals among the receiving signals. The touch sensing controller controls a timing of the driving signals and a generation of the differential signals.

The touch sensing controller may control the transmitting unit to sequentially provide the driving signals to the driving lines and may control the generation of the differential signals when a touch sensing operation for a first driving line among the driving lines is performed. Each of the differential signals may be generated by pairing two receiving signals of the receiving signals.

The differential signal generator may include a common mode amplifier and switching block. The common mode amplifier may exclude a common signal common to two receiving signals of the receiving signals from each of the two receiving signals. The switching block may include a plurality of switching units for selectively connecting the receiving lines to the common mode amplifier. The touch sensing controller may control the switching block to connect a first receiving line and a second receiving line of the receiving lines to the common mode amplifier in a first touch sensing period of a touch sensing period.

The touch sensing controller may control the switching block to connect the second receiving line and a third receiving line of the receiving lines to the common mode amplifier in a second touch sensing period of the touch sensing period.

The touch sensing system may further include a charge integrator for integrating charges corresponding to the differential signals. The touch sensing controller may reset the charges integrated by the charge integrator during the first touch sensing period when the first touch sensing period ends and may reset the charges integrated by the charge integrator during the second touch sensing period when the second touch sensing period ends.

The switching block may include at least one multiplexer having an input and output ratio of N+1:N (N is a natural number).

The differential signal generator may include a plurality of common mode amplifiers. Each of the common mode amplifiers may include a first terminal and a second terminal connected to two receiving lines among the receiving lines. A common voltage for excluding a common signal common to the two receiving signals from each of the two receiving signals received from the two receiving lines may be applied to the common mode amplifier.

According to an exemplary of the present inventive concept, there is provided a touch sensing system. The touch sensing system includes a transmitting unit and a receiving unit. The transmitting unit provides first signals to the touch panel. The receiving unit receives second signals generated by the touch panel in response to the first signals. The receiving unit includes a differential signal generator configured to generate a first differential signal from a first pair of the second signals.

The differential signal generator may output a signal generated by excluding a common signal common to the first pair of the second signals from each of the first pair of the second signals as the first differential signal.

The differential signal generator may include a first node and a second node to which input voltages corresponding to the second signals are selectively applied. The differential signal generator may further include a common mode amplifier to which a common voltage for excluding the common signal is applied.

The common mode amplifier may include an input unit, an amplifying unit, and output unit. The input unit may selectively provide a current to the amplifying unit based on information on magnitudes of the input voltages and the common voltage. The amplifying unit may amplify the current provided from the input unit. The output unit may output an output signal for excluding the common signal.

The differential signal generator may generate a second differential signal from a second pair of the second.

### BRIEF DESCRIPTION OF THE DRAWINGS

Exemplary embodiments of the present inventive concept will be more clearly understood from the following detailed description taken in conjunction with the accompanying drawings in which:

FIG. 1 is a block diagram illustrating a touch sensing device according to an exemplary embodiment of the present inventive concept;

FIG. 2 is a view illustrating a touch sensor included in a touch screen panel of FIG. 1 according to an exemplary embodiment of the present inventive concept;

FIG. 3 is a view illustrating a change in capacitance caused by a touch when a touch screen panel operates in a mutual capacitance sensing mode according to an exemplary embodiment of the present inventive concept;

FIGS. 4A and 4B are graphs illustrating an amount of change in capacitance in accordance with a touch when noise exists in a display panel according to an exemplary embodiment of the present inventive concept;

FIG. 5 is a view illustrating a part of a display device that includes the touch sensing device of FIG. 1 according to an exemplary embodiment of the present inventive concept;

FIGS. 6A and 6B are block diagrams illustrating a differential signal generator of FIG. 1 according to an exemplary embodiment of the present inventive concept;

FIG. 7 is a block diagram illustrating a charge integrator according to an exemplary embodiment of the present inventive concept;

FIG. 8 is a circuit diagram illustrating a touch sensing device according to an exemplary embodiment of the present inventive concept;

FIG. 9 is a circuit diagram illustrating a touch sensing device according to an exemplary embodiment of the present inventive concept;

FIG. 10 is a block diagram illustrating a common mode amplifier according to an exemplary embodiment of the present inventive concept;

FIGS. 11A and 11B are circuit diagrams illustrating a common mode amplifier according to an exemplary embodiment of the present inventive concept;

FIG. 12 is a block diagram illustrating a differential signal generator according to an exemplary embodiment of the present inventive concept;

FIGS. 13A and 13B are timing diagrams in a mutual capacitance sensing mode and a self-capacitance sensing mode according to an exemplary embodiment of the present inventive concept;

FIG. 14 is a view illustrating a printed circuit board (PCB) structure of a display device in which a touch screen panel is mounted according to an exemplary embodiment of the present inventive concept;

FIG. 15 is a block diagram illustrating a display chip integrated circuit (IC) according to an exemplary embodiment of the present inventive concept; and

FIG. 16 is a view illustrating exemplary applications of various products in each of which a touch sensing system according to an exemplary embodiment of the present inventive concept is mounted.

### DETAILED DESCRIPTION OF THE EMBODIMENTS

The present inventive concept will now be described more fully with reference to the accompanying drawings, in which exemplary embodiments thereof are shown. Like reference numerals may refer to like elements in the drawings and specification. The present inventive concept may, however, be embodied in many different forms and should not be construed as limited to the exemplary embodiments set forth herein. In the drawings, the thicknesses of elements may be exaggerated for clarity.

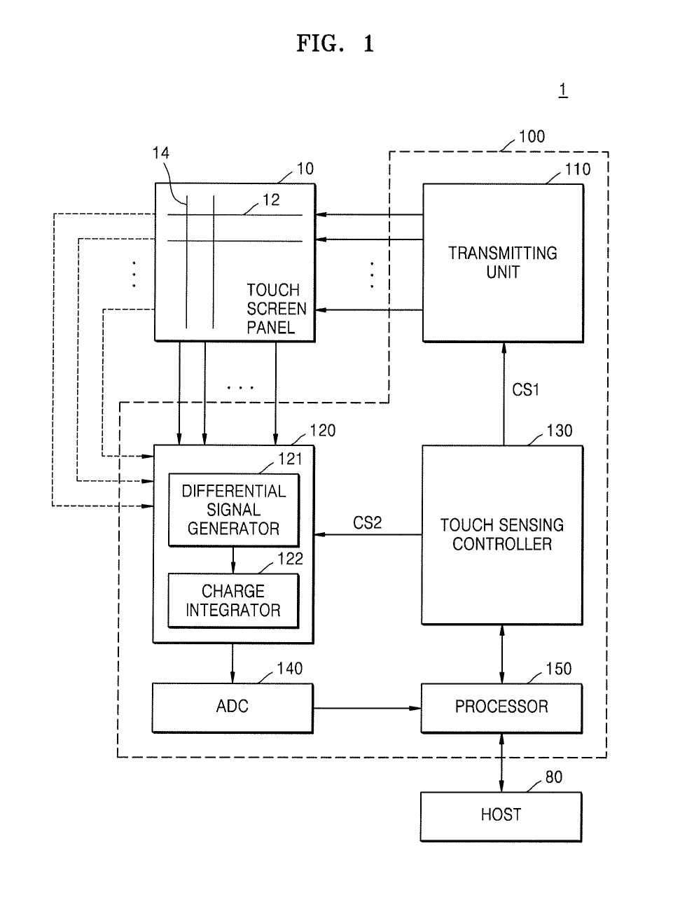

FIG. 1 is a block diagram illustrating a touch sensing device 1 according to an exemplary embodiment of the present inventive concept.

Referring to FIG. 1, the touch sensing device 1 includes a touch screen panel 10 and a touch circuit 100. In addition, the touch circuit 100 may provide coordinate values of touch sensing information to an external host 80. In the touch screen panel 10, as illustrated in FIG. 1, driving lines 12 arranged in a first direction and receiving lines 14 arranged in a second direction that intersects the first direction may be formed. Driving signals may be applied to the driving lines 12 and the receiving lines 14 may output receiving signals generated by the driving signals. When a touch is generated, a change in capacitance of a coupling capacitor occurs at an intersection of the driving lines 12 and the receiving lines 14 which is near a position in which the touch is generated, and thus, the touch screen panel 10 may provide the receiving signals corresponding to an amount of change in capacitance to the touch circuit 100.

The touch circuit 100 includes a transmitting unit 110, a receiving unit 120, a touch sensing controller 130, an analog-to-digital converter (ADC) 140, and a processor 150. The transmitting unit 110 transmits the driving signals to the plurality of driving lines 12 formed in the touch screen panel 10. At this time, the number of driving signals may be determined in accordance with the number of driving lines 12 of the touch screen panel 10.

The receiving unit 120 includes a differential signal generator 121 and a charge integrator 122. The receiving unit 120 is electrically connected to the receiving lines 14 of the touch screen panel 10 and receives the receiving signals for the touch screen panel 10 to sense the touch. At this time, the number of receiving signals may be determined in accordance with the number of receiving lines 14 of the touch screen panel 10.

The differential signal generator 121 may pair at least two receiving signals of the receiving signals and may exclude a common signal between the paired receiving signals from each of the paired receiving signals to generate differential signals. In an exemplary embodiment of the present inventive concept, to pair the receiving signals, the differential signal generator 121 may further include a switching block including a plurality of switching units for selectively connecting the receiving lines 14 to the differential signal generator 121. For example, there may be a common signal between a first receiving signal output from a first receiving line of the receiving lines 14 and a second receiving signal output from a second receiving line of the receiving lines 14, and the common signal may be excluded from the first receiving signal and the second receiving signal to generate a differential signal. For example, there may be a common signal between a third receiving signal output from a third receiving line 14 of the receiving lines and a fourth receiving signal output from a fourth receiving line of the receiving lines 14, and the common signal may be excluded from the third receiving signal and the fourth receiving signal to generate a differential signal. The first to fourth receiving lines may be adjacent to each other. After performing a first touch sensing operation based on the generated differential signals, as a second touch sensing operation, the receiving signals may be differently paired from one another and a common signal between the differently paired receiving signals may be excluded from each of the differently paired receiving signals to generate different differential signals. For example, in the second touch sensing operation, a common signal between the second receiving signal output from the second receiving line and the third receiving signal output from the third receiving line is excluded from the second receiving signal and the third receiving signal to generate a differential signal, and a common signal between the fourth receiving signal output from the fourth receiving line and a fifth receiving signal output from a fifth receiving line adjacent to the fourth receiving line is excluded from the fourth receiving signal and the fifth receiving signal to generate a differential signal. Thus, a touch sensing operation may be performed based on the generated differential signals.

The first touch sensing operation and the second touch sensing operation may be performed in a touch sensing period for one driving line in a mutual capacitance sensing mode and may be performed in a touch sensing period for a plurality of driving lines 12 or a plurality of receiving lines 14 in a self-capacitance sensing mode. The mutual capacitance sensing mode and the self-capacitance sensing mode will be described in detail later.

The charge integrator 122 may receive the differential signals output from the differential signal generator 121, may filter a noise component included in the differential signals, may integrate charges corresponding to the differential signals of which the noise component is filtered, and may form signals based on the integrated charges. Thus, touch sensitivity of the touch sensing device 1 may be increased.

The touch sensing controller 130 controls the touch sensing device 1 to perform an operation in the mutual capacitance sensing mode or the self-capacitance sensing mode. In the mutual capacitance sensing mode, the touch sensing controller 130 may apply a first control signal CS1 to the transmitting unit 110 and may control the transmitting unit 110 to transmit the driving signals to the driving lines 12 of the touch screen panel 10. At this time, the touch sensing controller 130 may control the transmitting unit 110 to sequentially transmit the driving signals to the respective driving lines 12. In an exemplary embodiment of the present inventive concept, the touch sensing controller 130 may control transmission of a driving signal for a first driving line among the driving lines 12 and then, may control transmission of a driving signal for a second driving line among the driving lines 12 to perform a touch sensing operation for the first driving line and then, to perform a touch sensing operation for the second driving line.

The touch sensing controller 130 may apply a second control signal CS2 to the receiving unit 120 and may control generation of the differential signals. Each of the differential signals may be obtained by excluding a common signal between one pair of the receiving signals from each of the one pair of the receiving signals received by the receiving unit 120. In an exemplary embodiment of the present inventive concept, the touch sensing controller 130 may control a plurality of switching units included in the switching block for selectively connecting the receiving lines 14 to the differential signal generator 121 so that the first touch sensing operation and the second touch sensing operation may be performed in a period in which the touch sensing operation for the first driving line is performed.

In the self-capacitance sensing mode, the touch sensing controller 130 may apply the first control signal CS1 to the transmitting unit 110 and may block connection between the transmitting unit 110 and the driving lines 12 to prevent the driving signals from being provided. In addition, the touch sensing controller 130 may apply the second control signal CS2 to the receiving unit 120 to connect the driving lines 10 and the receiving unit 120 as marked with the dotted line of FIG. 1. In the self-capacitance sensing mode, a touch sensing operation for the driving lines 12 may be performed at one time and then, a touch sensing operation for the receiving lines 14 may be performed at one time. When the touch sensing operation for the driving lines 12 is performed, the receiving signals may be received from the driving lines 12, each of the differential signals among the respective receiving signals may be generated by the above-described method, and the touch sensing operation may be performed based on the generated differential signals, which will be described in detail later.

The receiving unit 120 may provide sensing signals generated based on the differential signals to the ADC 140. The ADC 140 may provide digital sensing data obtained by digitalizing the sensing signals to the processor 150. The processor 150 may analyze the sensing data and may output one or more coordinate values corresponding to a touch to a host 80. The sensing signals are generated based on the differential signals so that the noise component may be excluded and the touch sensing device may have increased touch sensitivity. The above-described signals may correspond to current or voltage components.

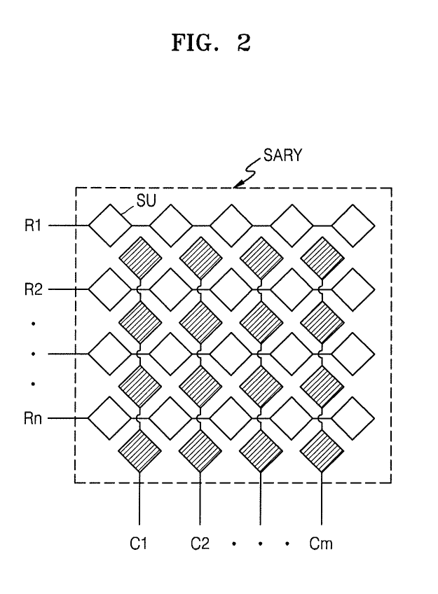

FIG. 2 is a view illustrating a touch sensor included in a touch screen panel 10 of FIG. 1 according to an exemplary embodiment of the present inventive concept.

The touch sensor may include a sensing array SARY including a plurality of rows R1, R2, . . . , and Rn and a plurality of columns C1, C2, . . . , and Cm. The plurality of rows R1, R2, . . . , and Rn are electrically connected to a plurality of sensing units SU, respectively. The plurality of columns C1, C2, . . . , and Cm are electrically connected to the plurality of sensing units SU, respectively. The touch sensor according to an exemplary embodiment of the present inventive concept may be a touch sensor in the mutual capacitance sensing mode or the self-capacitance sensing mode in which the sensing units SU therein generate a change in capacitance caused by a touch.

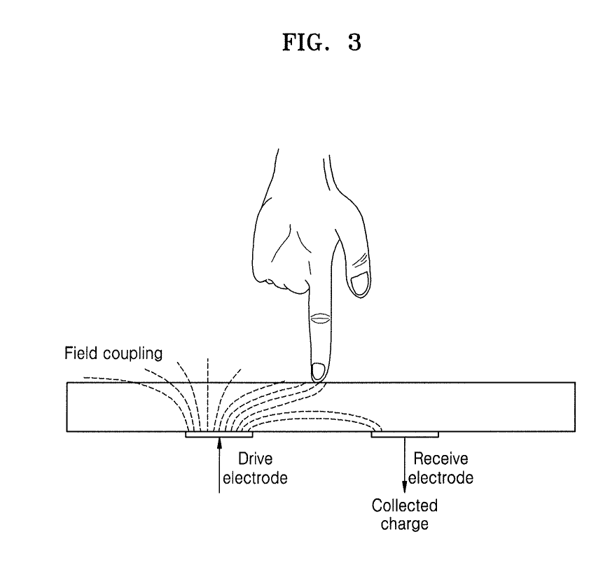

FIG. 3 is a view illustrating a change in capacitance caused by a touch when a touch screen panel operates in a mutual capacitance sensing mode according to an exemplary embodiment of the present inventive concept.

Referring to FIG. 3, in the mutual capacitance sensing mode, a voltage pulse is applied to a driving electrode and charges corresponding to the voltage pulse are collected by a receiving electrode. At this time, when a human finger contacts between the two electrodes, strength of an electric field (marked with a dotted line) may change. In addition, a change in the electric field may cause a change in capacitance. FIG. 3 illustrates a contact touch. However, the change in the electric field may be caused by a close touch. In addition, FIG. 3 illustrates the contact touch performed by a finger. However, the change in the electric field may also be caused by a touch performed by another conductor such as a touch pen, or the like.

Due to the change in the electric field between the two electrodes (e.g., a driving electrode and a receiving electrode), the capacitance between the electrodes may change and thus, a touch may be sensed. However, the present inventive concept is not limited thereto. FIG. 3 illustrates an exemplary embodiment in which the change of the electric field is sensed by the receiving electrode due to the change in capacitance. In an exemplary embodiment of the present inventive concept, the change in capacitance may be sensed by the two electrodes.

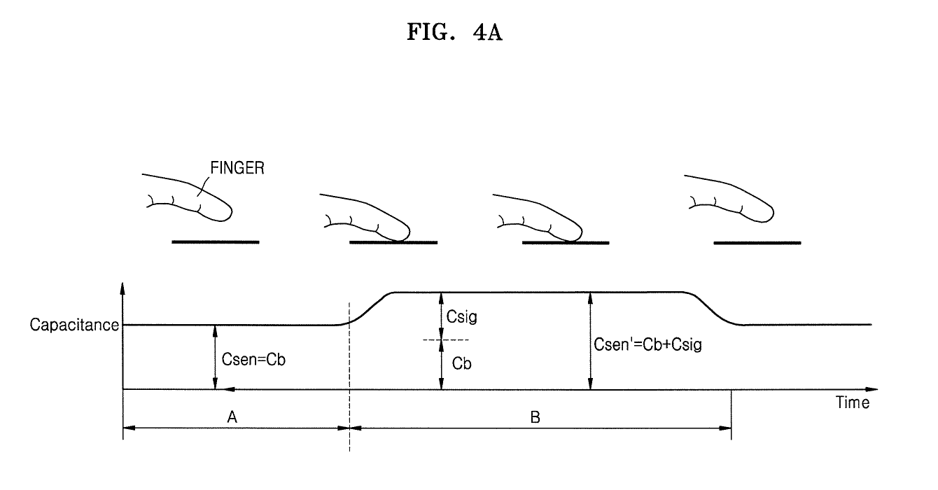

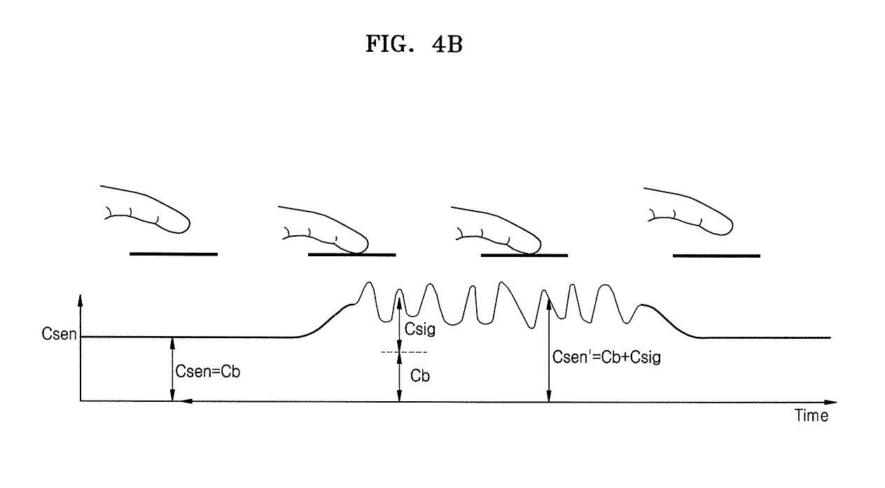

FIGS. 4A and 4B are graphs illustrating an amount of change in capacitance in accordance with a touch when noise exists in a display panel according to an exemplary embodiment of the present inventive concept.

Referring to FIG. 4A, each sensing unit SU has a parasitic capacitance value Cb. A capacitance value (e.g., the parasitic capacitance value Cb) of the sensing unit SU changes due to approach or contact of an object such as a finger, a touch pen, or the like, so that an additional capacitance component Csig may be generated. For example, when a conductive object approaches or contacts the sensing unit SU, a capacitance value of the sensing unit may increase.

In the section A of FIG. 4A, the conductive object does not contact the sensing unit SU and a capacitance value Csen of the sensing unit SU may correspond to a parasitic capacitance value Cb. In the section B of FIG. 4A, the conductive object contacts the sensing unit SU. When the conductive object contacts the sensing unit SU, a capacitance value Csig may be generated between a finger and a touch screen panel in addition to the parasitic capacitance value Cb, so that a capacitance value Csen′ may increase to a value of Cb+Csig, as illustrated in FIG. 4A.

As illustrated in FIG. 4B, when various noise components exist, the noise components affect the capacitance value. For example, the capacitance value Csen′ may fluctuate and thus, a touch may not be correctly sensed by the capacitance value Csen′. Accordingly, sensing sensitivity of a touch screen device may deteriorate.

The noises may be differently generated in a liquid crystal display (LCD) panel and an organic light emitting diode (OLED) display panel among display panels. For example, when a touch panel is positioned on an OLED cell, a common electrode layer that generates a common voltage Vcom is positioned under a touch sense channel. The common electrode layer maintains a uniform constant voltage by using an external switching mode power supply (SMPS). Therefore, in the OLED display panel, an amount of noise induced to a touch sense channel may be relatively small.

In the LCD panel, a common electrode may be driven by a constant voltage or by continuously inverted voltages. For example, a voltage of the common electrode may be about 5V so that a voltage induced to the touch sense channel may not be negligible. In the method of driving the common electrode with continuously inverted voltages, a large amount of noise may be induced. In addition, in the method of driving the common electrode by the constant voltage, a large amount of noise may be induced when data is written in a source channel because of slew as well as the data written in the source channel.

Therefore, the touch sensing device according to an exemplary embodiment of the present inventive concept includes the differential signal generator 121 for generating the differential signals obtained by excluding the noise component (e.g., the common signal) among the respective receiving signals and the charge integrator 122 for excluding the noise component generated by the method of driving the common electrode by the constant voltage to increase the touch sensitivity.

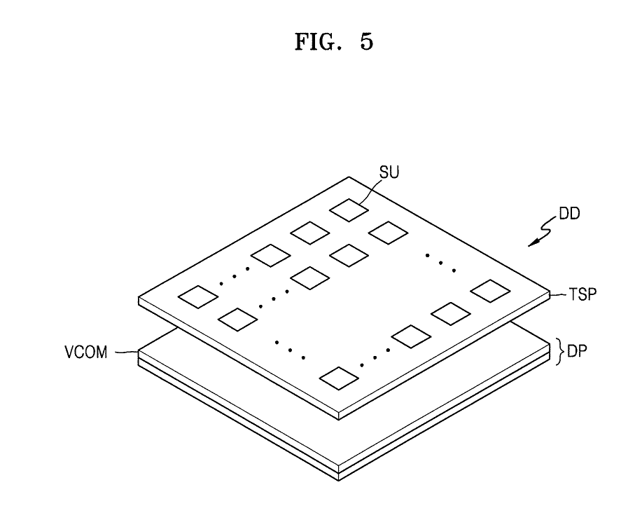

FIG. 5 is a view illustrating a part of a display device that includes the touch sensing device 1 of FIG. 1 according to an exemplary embodiment of the present inventive concept. Referring to FIG. 5, a display device DD may include a display panel DP and a touch screen panel TSP. The display device DD may be an LCD, a field emission display device (FED), an OLED, a plasma display device (PDP), or the like. The display panel DP may be implemented by a structure and a material corresponding to a type of the display device DD.

The touch screen panel TSP may be integrated with the display panel DP of the display device DD. In FIG. 5, the touch screen panel TSP may be positioned on the display panel DP. However, the present inventive concept is not limited thereto. For example, the touch screen panel TSP may be positioned under the display panel DP. Hereinafter, for convenience's sake, the touch screen panel TSP is described as being positioned on the display panel DP. The touch screen panel TSP may be separated from the display panel DP by a predetermined distance or may be attached to a top plate of the display panel DP. For example, when the display panel DP is an LCD panel, a common voltage electrode VCOM may be provided in the top plate of the display panel DP. In this case, a vertical parasitic capacitance component Cv may be formed between each of the sensing units SU and the common voltage electrode VCOM that is located in a vertical direction of each sensing unit SU. However, the present inventive concept is not limited thereto. The vertical parasitic capacitance component Cv may be formed between each of the sensing units SU and a ground voltage electrode included in the touch screen panel TSP.

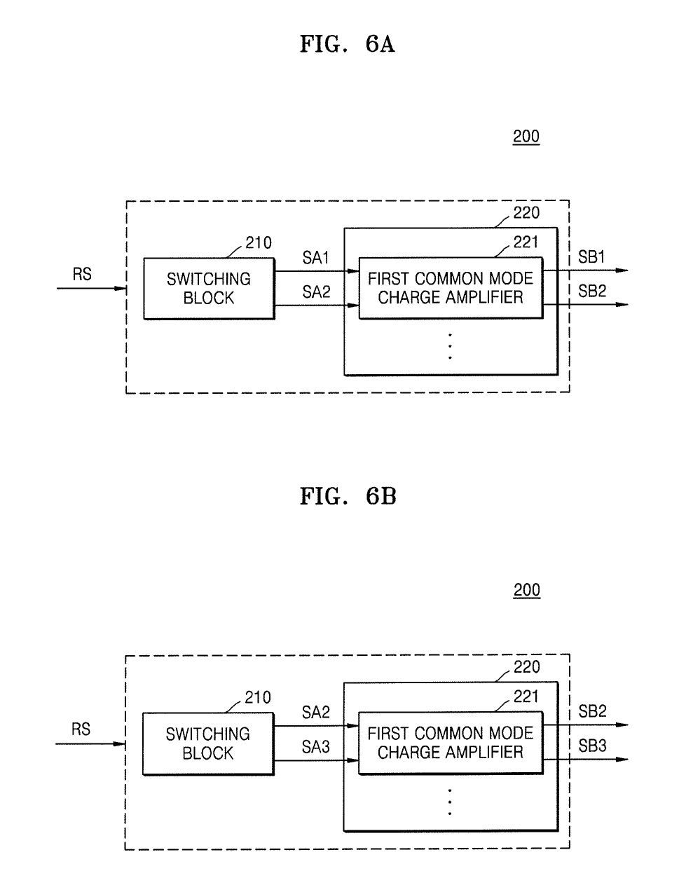

FIGS. 6A and 6B are block diagrams illustrating a differential signal generator 121 of FIG. 1 according to an exemplary embodiment of the present inventive concept.

In the mutual capacitance sensing mode, the first touch sensing operation and the second touch sensing operation may be performed in a period (e.g., a touch sensing operation period) when a touch sensing operation for one driving line is performed. In addition, in the self-capacitance sensing mode, the first touch sensing operation and the second touch sensing operation may be performed in a period when a touch sensing operation for a plurality of driving lines 12 or a plurality of receiving lines 14.

Referring to FIG. 6A, a differential signal generator 200 includes a switching block 210 and a common mode charge amplifying unit 220 including a first common mode charge amplifier 221. When the first touch sensing operation is performed, the differential signal generator 200 may receive receiving signals RS from the touch screen panel 10 of FIG. 1 and the switching block 210 may include a plurality of switching units for selectively connecting the common mode charge amplifying unit 220 to the driving lines 12 or the receiving lines 14 of FIG. 1.

For example, in the mutual capacitance sensing mode, the first receiving line and the third receiving line may be positioned on both sides of the second receiving line. The switching block 210 may connect the first receiving line and the second receiving line to the first common mode charge amplifier 221. Therefore, a first receiving signal SA1 and a second receiving signal SA2 may be provided to the first common mode charge amplifier 221, respectively, through the first receiving line and the second receiving line. The first common mode charge amplifier 221 may exclude a common signal CM1 between the first receiving signal SA1 and the second receiving signal SA2 from the first receiving signal SA1 to generate a first differential signal SB1. The first common mode charge amplifier 221 may exclude the common signal CM1 from the second receiving signal SA2 to generate a second differential signal SB2.

In addition, referring to FIG. 6B, when the second touch sensing operation is performed, as described above, the touch sensing controller 130 of FIG. 1 may control the switching block to block a connection between the first receiving line and the first common mode charge amplifier 221, to maintain a connection between the second receiving line and the first common mode charge amplifier 221, and to connect the third receiving line and the first common mode charge amplifier 221. Therefore, the second receiving signal SA2 and a third receiving signal SA3 may be provided to the first common mode charge amplifier 221, respectively, through the second receiving line and the third receiving line. The first common mode charge amplifier 221 may exclude a common signal CM2 between the second receiving signal SA2 and the third receiving signal SA3 from the second receiving signal SA2 to generate a third differential signal SB3. The first common mode charge amplifier 221 may exclude the common signal CM2 from the third receiving signal SA3 to generate a fourth differential signal SB4. In addition, the first common mode charge amplifier 221 may generate differential signals by pairing each of receiving signals received through receiving lines at both sides of the second receiving line to the second receiving signal SA2 of the second receiving line. For example, the first common mode charge amplifier 221 may generate a differential signal between the second receiving signal SA2 of the second receiving line and the first receiving signal SA1 of the first receiving line and may generate a differential signal between the second receiving signal SA2 of the second receiving line and the third receiving signal SA3 of the third receiving line. Thus, the touch sensing operation may be performed based on the differential signals and the touch sensitivity may be increased. In addition, in an exemplary embodiment of the present inventive concept, the first to fourth differential signals SB1 to SB4 may be generated in a period in which a driving signal is transmitted to one driving line to perform the touch sensing operation, which may be also applied in the self-capacitance sensing mode.

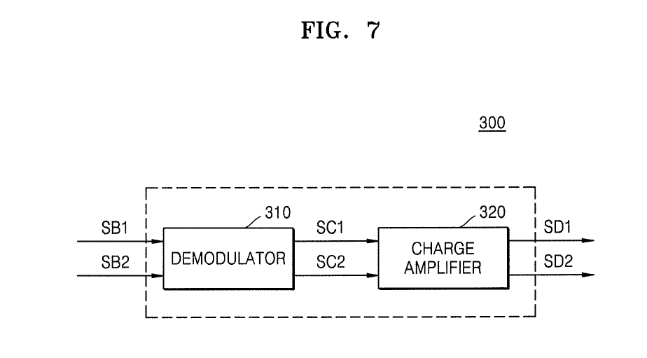

FIG. 7 is a block diagram illustrating a charge integrator 300 according to an exemplary embodiment of the present inventive concept.

Referring to FIG. 7, the charge integrator 300 includes a demodulator 310 and a charge amplifier 320. The demodulator 310 may receive the first differential signal SB1 and the second differential signal SB2 from the differential signal generator 200 of FIG. 6A. The first differential signal SB1 and the second differential signal SB2 may include various noise components as illustrated in FIG. 4. The demodulator 310 may convert the noise components into high frequency noise components having a higher frequency than that of the noise components. In addition, the demodulator 310 may convert differential signals SB1 and SB2 excluding the noise components into direct current (DC) component signals having a uniform level. The demodulator 310 may provide a first demodulation signal SC1 obtained by converting the first differential signal SB1 and a second demodulation signal SC2 obtained by converting the second differential signal SB2 by the above-described method to the charge amplifier 320. The charge amplifier 320 may filter the high frequency noise components from the first demodulation signal SC1 and the second demodulation signal SC2, may integrate charges corresponding to the first demodulation signal SC1 and the second demodulation signal SC2 from which the high frequency noise components are filtered, and may generate a first sensing signal SD1 and a second sensing signal SD2 based on the integrated charges to perform the first touch sensing operation.

In addition, the demodulator 310 may receive the second differential signal SB2 and the third differential signal SB3 from the differential signal generator 200 of FIG. 6B. The sensing signals SD1 and SD2 may be generated by the above-described demodulator 310 and charge amplifier 320 by the same method as the above-described method so that the second touch sensing operating may be performed. The first touch sensing operation and the second touch sensing operation may be sequentially performed in a period in which one touch sensing operation is performed.

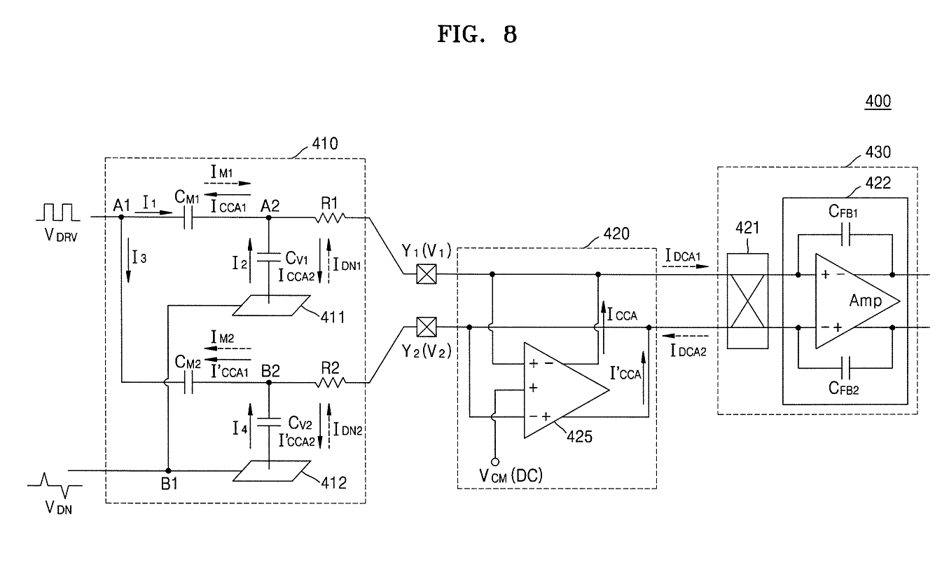

FIG. 8 is a circuit diagram illustrating a touch sensing device 400 according to an exemplary embodiment of the present inventive concept.

Referring to FIG. 8, the touch sensing device 400 includes a touch screen panel 410, a node Y1 and a node Y2 which are connected to the touch screen panel 410, a common mode charge amplifier 420, and a charge integrator 430. In addition, the charge integrator 430 includes a demodulator 421 and a charge amplifier 422. In an exemplary embodiment of the present inventive concept, in the mutual capacitance sensing mode, the node Y1 and the node Y2 may be respectively connected to the receiving line C1 and the receiving line C2 of FIG. 2. When a driving voltage V_{DRV} is provided to a node A1 of the touch screen panel 410, a first mutual current I₁ flows through a first capacitor C_{M1} and a second mutual current I₃ flows through a second capacitor C_{M2}. In addition, when a noise voltage V_{DN} caused generated by the noise component described in FIGS. 4A and 4B is provided to a node B1, a first noise current I₂ flows through a third capacitor C_{V1} corresponding to the vertical parasitic capacitance component described in FIG. 5 and a second noise current I₄ flows through a fourth capacitor C_{V2} corresponding to another vertical parasitic capacitance component.

Corresponding to the driving voltage V_{DRV}, a first voltage V1 may be applied to the node Y1 and a second voltage V2 may be applied to the node Y2. A differential signal generator (e.g., the common mode charge amplifier 420) may include a differential amplifier (e.g., a common mode amplifier 425). The first voltage V1, the second voltage V2, and a common voltage V_{CM} are input to the common mode amplifier 425. The common voltage V_{CM} may be a DC voltage having a uniform level. The common voltage V_{CM} may be a voltage for operating the common mode amplifier 425 and may be variously set in accordance with a voltage range of the driving voltage V_{DRV} having a square pulse shape. The common mode amplifier 425 may absorb a common current I_{CCA} at an output port. In an exemplary embodiment of the present inventive concept, the common mode amplifier 425 may convert an intermediate voltage (V1+V2)/2 of the first voltage V1 and the second voltage V2 into the common voltage V_{CM} in a common mode. In a differential mode, the common mode amplifier 425 may make a difference between the first voltage V1 and the second voltage V2 near 0 to amplify a differential current component. In accordance with the operation of the common mode amplifier 425 in the common mode and the differential mode, the first voltage V1 and the second voltage V2 may have the same voltage level as the common voltage V_{CM}.

Flows of currents may be formed as illustrated in TABLE 1. In an exemplary embodiment of the present inventive concept, the common voltage V_{CM} may be provided by a receiving unit of the touch sensing device 400.

TABLE 1

| | |
|---|---|
| I_{CCA} = I_{CCA1} + I_{CCA2} | I′_{CCA} = I′_{CCA1} + I′_{CCA2} |
| I₁ − I_{CCA1} = I_{M1} | I₃ − I′_{CCA1} = I_{M2} |
| I₂ − I_{CCA2} = I_{DN1} | I₄ − I′_{CCA2} = I_{DN2} |
| I_{DCA1} = I_{M1} + I_{DN1} | I_{DCA2} = I_{M2} + I_{DN2} |

As illustrated in the TABLE 1, the common mode amplifier 425 absorbs the first common current I_{CCA} so that a first mutual common current I_{CCA1} is excluded from the first mutual current I₁ and a first mutual differential current I_{M1} may flow through the first capacitor C_{M1}. In addition, a first noise common current I_{CCA2} is excluded from the first noise current I₂ so that a first noise differential current I_{DN1} may flow through the third capacitor C_{V1}. Thus, a first differential current I_{DcA1} that is the sum of the first mutual differential current I_{M1} and the first noise differential current I_{DN1} may be provided to the demodulator 421.

In addition, the common mode amplifier 425 absorbs a second common current I′_{CCA} so that a second mutual common current I′_{CCA1} is excluded from the second mutual current I₃ and a second mutual differential current I_{M2} may flow through the second capacitor C_{M2}. In addition, a second noise common current I′_{CCA2} is excluded from the second noise current I₄ so that a second noise differential current I_{DN2} may flow through the fourth capacitor Cᵥ₂. Thus, a second differential current I_{DcA2} that is the sum of the second mutual differential current I_{M2} and the second noise differential current I_{DN2} may be provided to the demodulator 421.

The demodulator 421 receives the first differential current I_{DCA1} and converts the first noise differential current I_{DN1} of the first differential current I_{DCA1} into a current having a higher frequency than that of the first noise differential current I_{DN1}. In addition, the first mutual differential current I_{M1} of the first differential current I_{DCA1} may be demodulated to a DC current having a uniform level. The demodulator 421 receives the second differential current I_{DcA2} and converts the second noise differential current I_{DN2} of the second differential current I_{DcA2} into a current having a higher frequency than that of the second noise differential current I_{DN2}. In addition, the second mutual differential current I_{M2} of the second differential current I_{DCA2} may be demodulated to a DC current having a uniform level.

The charge amplifier 422 includes an amplifier Amp, a first integrating capacitor C_{FB1}, and a second integrating capacitor C_{FB2}. The first noise differential current I_{DN1} and the second noise differential current I_{DN2} that are demodulated to currents having higher frequencies may be filtered. Therefore, the noise components corresponding to the first and second noise differential currents I_{DN1} and I_{DN2} may be excluded, and the first integrating capacitor C_{FB1} and the second integrating capacitor C_{FB2} may respectively integrate charges corresponding to the first mutual differential current I_{M1} and the second mutual differential current I_{M2} that are demodulated to currents having lower frequencies. A touch sensing operation according to an exemplary embodiment of the present inventive concept may be performed based on the integrated charges so that touch sensitivity may be increased. The touch sensing device 400 may be formed of various circuit configurations.

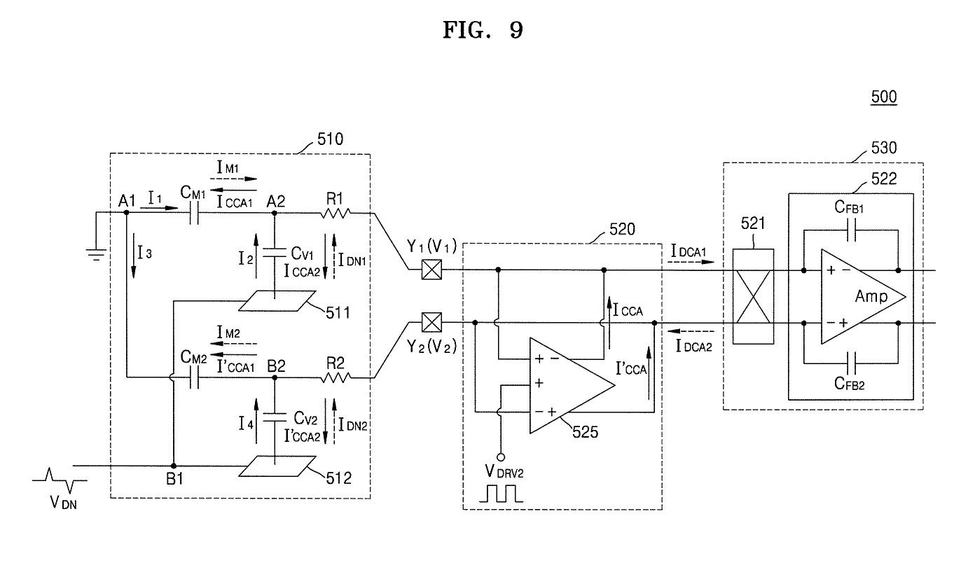

FIG. 9 is a circuit diagram illustrating a touch sensing device 500 according to an exemplary embodiment of the present inventive concept.

Referring to FIG. 9, the touch sensing device 500 has the same configuration as the touch sensing device 400 of FIG. 8. However, since the touch sensing device 500 is in the self-capacitance sensing mode, a voltage provided to the touch sensing device 500 may be different from the voltage provided to the touch sensing device 400 of FIG. 8. A node A1 is grounded unlike the node A1 of FIG. 8 and a square pulse type common voltage V_{DRV2} may be provided to a common mode amplifier 525 unlike in FIG. 8. The common voltage V_{DRV2} may be determined by a voltage at which an analog chip in a circuit of the touch sensing device 500 according to an exemplary embodiment of the present inventive concept may operate. In an exemplary embodiment of the present inventive concept, the common voltage V_{DRV2} may be provided by the receiving unit of the touch sensing device 400. Since the touch sensing device 500 may perform the same operation as the touch sensing device 400 of FIG. 8, detailed description will be omitted.

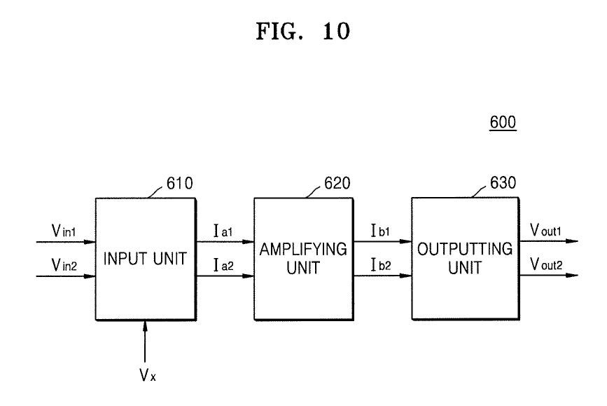

FIG. 10 is a block diagram illustrating a common mode amplifier 600 according to an exemplary embodiment of the present inventive concept.

Referring to FIG. 10, the common mode amplifier 600 includes an input unit 610, an amplifying unit 620, and an output unit 630. The input unit 610 may receive a first input voltage Vin1 and a second input voltage Vin2 which correspond to two receiving signals, respectively, received from two receiving lines of a touch screen panel. In addition, the input unit 610 may receive a common voltage Vx for operating the input unit 610. The input unit 610 may control the first input voltage Vin1 and the second input voltage Vin2 to have a voltage value corresponding to the common voltage Vx. In addition, the input unit 610 may control selective provision of currents to the amplifying unit 620 based on a difference in magnitude among the first input voltage Vin1, the second input voltage vin2, and the common voltage Vx. The currents are selectively provided to the amplifying unit 620 so that the common mode amplifier 600 may exclude a common signal between the receiving signals.

The amplifying unit 620 amplifies the currents Iₐ₁ and Iₐ₂ which are selectively provided by the input unit 610 and may provide amplified currents I_{b1} and I_{b2} to the output unit 630. The output unit 630 may output output voltages Vₒᵤₜ₁ and Vₒᵤₜ₂ based on the amplified currents I_{b1} and I_{b2}. The output voltages Vₒᵤₜ₁ and Vₒᵤₜ₂ may be output signals for excluding the common signal between the receiving signals.

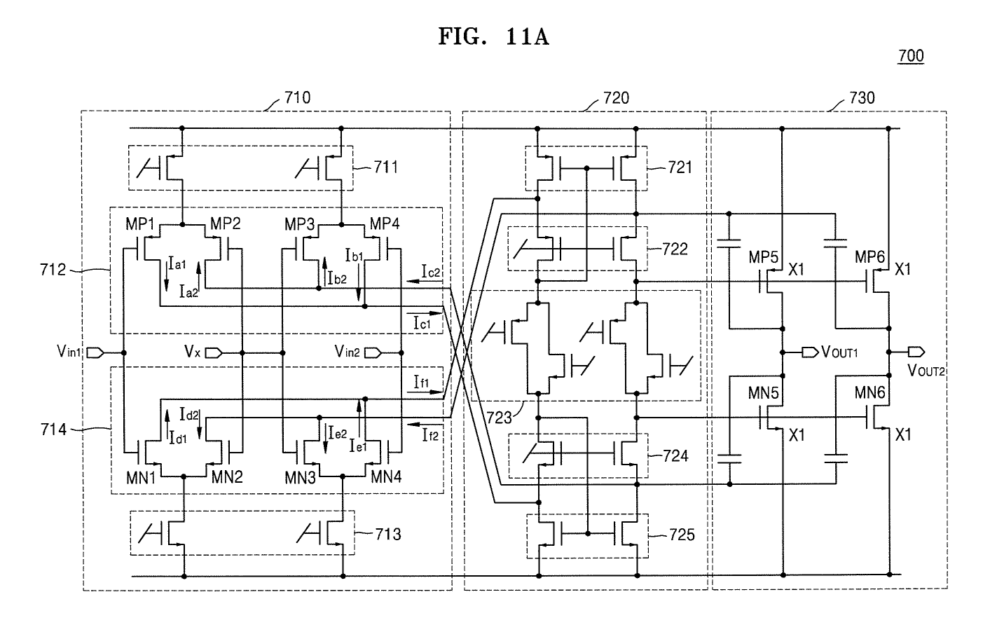

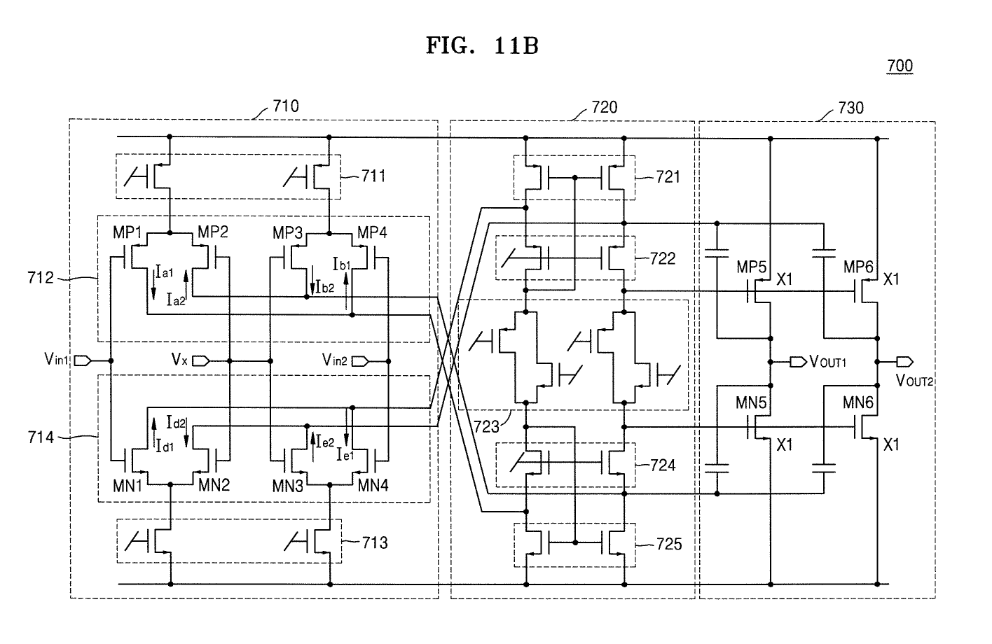

FIGS. 11A and 11B are circuit diagrams illustrating a common mode amplifier 700 according to an exemplary embodiment of the present inventive concept.

Referring to FIG. 11A, the common mode amplifier 700 includes an input unit 710, an amplifying unit 720, and an output unit 720. The input unit 710 includes a first input unit 712 having a plurality of PMOSs, a first bias 711 for setting an operation point of the first input unit 712, a second input unit 714 having a plurality of PMOSs, and a second bias 713 for setting an operation point of the second input unit 714. The output unit 720 may include current mirrors 721 and 725, cascade circuits 722 and 724, and a bias circuit 723.

The input unit 710 may receive a first input voltage Vᵢₙ₁, a second input voltage Vᵢₙ₂, and a common voltage Vₓ and may selectively provide currents, which correspond to the first input voltage Vᵢₙ₁, the second input voltage Vᵢₙ₂, and the common voltage Vₓ, to the output unit 720. Further, the input unit 710 may selectively provide the currents to the output unit 720 based on the voltages (e.g., the first input voltage Vᵢₙ₁, the second input voltage Vᵢₙ₂, and the common voltage Vₓ) input thereto.

In an exemplary embodiment of the present inventive concept, when the first input voltage Vᵢₙ₁ and the second input voltage Vᵢₙ₂ are smaller than the common voltage Vₓ, the first input unit 712 may form a first selection current I_{c1} that flows through the amplifying unit 720 based on a first current Iₐ₁ that flows through a first PMOS MP1 port and a second current I_{b1} that flows through a fourth PMOS MP4 port. For example, the first selection current I_{c1} may be a sum of the first and second currents Iₐ₁ and I_{b1}. In addition, the first input unit 712 may form a second selection current I_{c2} that flows through the amplifying unit 720 based on a third current Iₐ₂ that flows through a second PMOS MP2 port and a fourth current I_{b2} that flows through a third PMOS MP3 port. For example, the second selection current I_{c2} may be a sum of the third and fourth currents Iₐ₂ and I_{b2}. The second input unit 714 may form a third selection current I_{c3} and a fourth selection current I_{c4} that flow through the amplifying unit 720 as illustrated in FIG. 11A. In an exemplary embodiment of the present inventive concept, when the first input voltage Vᵢₙ₁ and the second input voltage Vᵢₙ₂ are larger than the common voltage Vₓ, currents that flow through the amplifying unit 720 may be selectively formed. In an exemplary embodiment of the present inventive concept, the input unit 710 may include only the first input unit 712 or the second input unit 714.

Referring to FIG. 11B, in an exemplary embodiment of the present inventive concept, when the first input voltage is smaller than the common voltage Vₓ and the second input voltage Vᵢₙ₂ is larger than the common voltage Vₓ, in the first input unit 712, the first current Iₐ₁ that flows through the first PMOS MP1 port and the second current I_{b1} that flows through the fourth PMOS MP4 port form a closed loop so that a current may not be provided to the amplifying unit 720. In addition, in the first input unit 712, the third current Iₐ₂ that flows through the second PMOS MP2 port and the fourth current I_{b2} that flows through the third PMOS MP3 port form a closed loop so that no current may be provided to the amplifying unit 720. In the second input unit 714, like in the first input unit 712, currents may form closed loops so that no current may be provided to the amplifying unit 720. In addition, even when the first input voltage Vᵢₙ₁ is larger than the common voltage Vₓ and the second input voltage Vᵢₙ₂ is smaller than the common voltage Vₓ, the input unit 710 may not provide a current to the amplifying unit 720.

As described above, the input unit 710 selectively provides a current to the amplifying unit 720 based on information on the magnitudes of the input voltages so that the common mode amplifier 700 may absorb a common signal or a common current corresponding to the common signal.

FIG. 12 is a block diagram illustrating a differential signal generator 800 according to an exemplary embodiment of the present inventive concept.

Referring to FIG. 12, the differential signal generator 800 includes a switching block unit 810 and a common mode amplifying unit 820. The switching block unit 810 may include a plurality of multiplexers MUX 811 and 812 having an input and output number ratio of 3:2. In an exemplary embodiment of the present inventive concept, a terminal Y1, a terminal Y2, a terminal Y3, and a terminal Y4 may be respectively connected to the receiving line C1, the receiving line C2, the receiving line C3, and the receiving line C4 of FIG. 2. According to an exemplary embodiment of the present inventive concept, in the self-capacitance sensing mode, the terminal Y1, the terminal Y2, the terminal Y3, and the terminal Y4 may be respectively connected to the receiving line R1, the receiving line R2, the receiving line R3, and the receiving line R4 of FIG. 2, by the touch sensing controller 130 of FIG. 1. However, the present inventive concept is not limited thereto. The switching block unit 810 may include a multiplexer MUX having an input and output number ratio of m:(m−1) (m is a natural number of no less than 1).

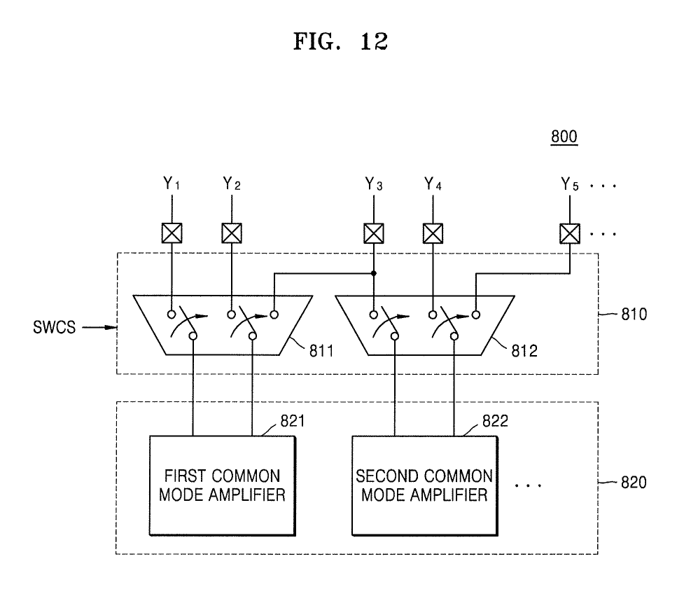

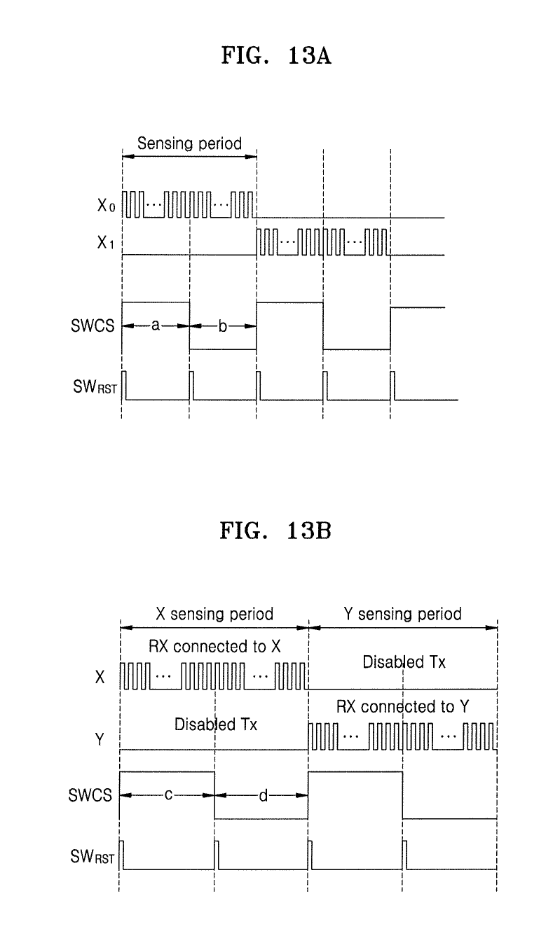

The common mode amplifying unit 820 may include a plurality of common mode amplifiers 821 and 822. The first multiplexer MUX 811 may selectively connect two terminals among the terminal Y1, the terminal Y2, and the terminal Y3 to the first common mode amplifier 821 based on a switching control signal SWCS and the second multiplexer MUX 812 may selectively connect two terminals among the terminal Y3, the terminal Y4, and the terminal Y5 to the second common mode amplifier 822 based on the switching control signal SWCS, which will be described with reference to FIGS. 13A and 13B.

FIGS. 13A and 13B are timing diagrams in a mutual capacitance sensing mode and a self-capacitance sensing mode according to an exemplary embodiment of the present inventive concept.

Referring to FIG. 13A, in the mutual capacitance sensing mode, driving voltages are sequentially applied to driving lines so that a touch sensing operation may be performed. For example, a driving signal is provided to a first driving line X1 in a touch sensing period and a receiving unit receives receiving signals corresponding to the driving signal to perform a touch sensing operation and then, a driving signal is provided to a second driving line X2 in a touch sensing period and the receiving unit receives receiving signals corresponding to the driving signal to perform a touch sensing operation, which is an exemplary embodiment of the present inventive concept. The present inventive concept is not limited thereto. The driving signals may be sequentially provided in various orders so that the touch sensing operation may be performed.

Referring to a timing diagram of a switching reset signal SW_{RsT} when a touch sensing operation is performed in a first touch sensing period a and a second touch sensing period b, the switching reset signal S_{WRST} is converted from a logic low L state to a logic high H state so that charges integrated in the first touch sensing period a and charges integrated in the second touch sensing period b each may be reset. The touch sensing controller 130 of FIG. 1 may control reset timing for the charges.

Referring to a timing diagram of the switching control signal SWCS illustrated in FIG. 13A, the switching control signal SWCS may have a logic high H state in the first touch sensing period a and a logic low L state in the second touch sensing period b. For example, in the first touch sensing period a, the terminal Y1 and the terminal Y2 of FIG. 12 may be connected to the first common mode amplifier 821, and the terminal Y3 and the terminal Y4 may be connected to the second common mode amplifier 822. Therefore, differential signals among the receiving signals received through the terminal Y1 and the terminal Y2 and differential signals among the receiving signals received through the terminal Y3 and the terminal Y4 may be generated. The differential signals may be referred to as first differential signals. In the second touch sensing period b, the terminal Y2 and the terminal Y3 of FIG. 12 may be connected to the first common mode amplifier 821 and the terminal Y4 and the terminal Y5 may be connected to the second common mode amplifier 822. Therefore, differential signals among the receiving signals received through the terminal Y2 and the terminal Y3 and differential signals among the receiving signals received through the terminal Y4 and the terminal Y5 may be generated. The differential signals may be referred to as second differential signals. The first touch sensing period a and the second touch sensing period b may form one touch sensing period. Differential signals are generated by differently paired receiving signals in one touch sensing period and a touch sensing operation is performed based on the generated differential signals, and thus, touch sensitivity of a touch sensing device may be increased.

Referring to FIG. 13B, in the self-capacitance sensing mode, a touch sensing operation for driving lines 12 is performed and then, a touch sensing operation for receiving lines 14 may be performed. However, the present inventive concept is not limited thereto. For example, the touch sensing operation for the receiving lines 14 may be performed prior to the touch sensing operation for the driving lines 12. In an exemplary embodiment of the present inventive concept, in a driving line touch sensing period X, the driving lines 12 may be disconnected from a transmitting unit Tx and may be connected to a receiving unit Rx and, in a receiving line touch sensing period Y, the driving lines 12 may be disconnected from the receiving unit Rx and may be connected to the receiving unit Rx, and thus, the touch sensing operation may be performed.

In the driving line touch sensing period X, a terminal Y1, a terminal Y2, a terminal Y3, a terminal Y4, and a terminal Y5 may be respectively connected to the driving line R1, the driving line R2, the driving line R3, the driving line R4, and the driving line R5. Referring to the timing diagram of the switching control signal SWCS, the switching control signal SWCS may have a logic high H state in a first driving line touch sensing period c and a logic low L state in a second driving line touch sensing period d. For example, in the first driving line touch sensing period c, the terminal Y1 and the terminal Y2 of FIG. 12 may be connected to the first common mode amplifier 821 and the terminal Y3 and the terminal Y4 may be connected to the second common mode amplifier 822. Therefore, differential signals among the receiving signals received through the terminal Y1 and the terminal Y2 and differential signals among the receiving signals received through the terminal Y3 and the terminal Y4 may be generated. The differential signals may be referred to as first differential signals. In the second driving line touch sensing period d, the terminal Y2 and the terminal Y3 of FIG. 12 may be connected to the first common mode amplifier 821 and the terminal Y4 and the terminal Y5 may be connected to the second common mode amplifier 822. Therefore, differential signals among the receiving signals received through the terminal Y2 and the terminal Y3 and differential signals among the receiving signals received through the terminal Y4 and the terminal Y5 may be generated. The differential signals may be referred to as second differential signals. The first driving line touch sensing period c and the second driving line touch sensing period d may form one driving line touch sensing period X. Differential signals are generated by differently paired receiving signals in the driving line touch sensing period X and a touch sensing operation is performed based on the generated differential signals.

In a receiving line touch sensing period Y, the terminal Y1, the terminal Y2, the terminal Y3, the terminal Y4, and the terminal Y5 may be respectively connected to the receiving line C1, the receiving line C2, the receiving line C3, the receiving line C4, and the receiving line C5. Operations in the receiving line touch sensing period Y may be substantially the same as in the driving line touch sensing period X. Therefore, detailed description for the operation in the receiving line touch sensing period Y will be omitted.

FIG. 14 is a view illustrating a printed circuit board (PCB) structure of a display device 1000 in which a touch screen panel is mounted according to an exemplary embodiment of the present inventive concept.

As illustrated in FIG. 14, the display device 1000 may include a window glass 1010, a touch screen panel 1020, and a display panel 1040. In addition, a polarizing plate 1030 for an optical characteristic may be provided between the touch screen panel 1020 and the display panel 1040. The window glass 1010 may include acryl or enhanced glass to protect a module against external shock or scratch caused by repetitive touches.

The touch screen panel 1020 may be formed by patterning a transparent electrode such as indium tin oxide (ITO), or the like on a transparent substrate. The transparent substrate may include polyethylene terephthalate (PET), polycarbonate (PC), poly methyl methacrylate (PMMA), polyethylene naphthalate (PEN), polyether sulfone (PES), cyclo-olefin polymer (COC), a triacetyl cellulose (TAC) film, a polyvinyl alcohol (PVA) film, a polyimide (PI) film, polystyrene (PS), biaxially oriented PS (BOPS), glass, enhanced glass, or the like.

A touch circuit 1020 (e.g., the touch circuit described in FIG. 1) may be mounted on a flexible printed circuit board (FPCB) in a chip on board (COB) type. The display panel 1040 may be formed by attaching two sheets of glass formed of a top plate and a bottom plate to each other. In addition, in a mobile display panel, a display driving circuit 1041 may be attached in a chip on glass (COG) type.

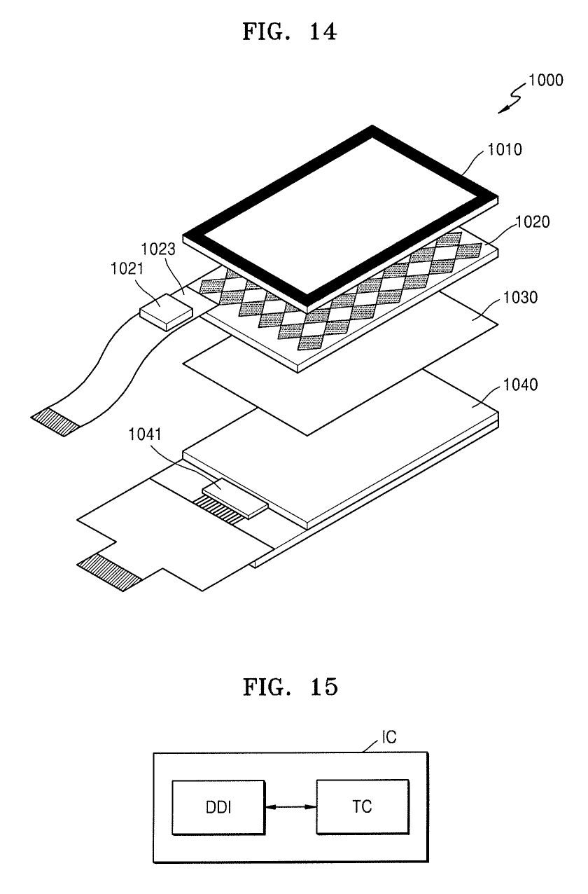

FIG. 15 is a block diagram illustrating a display chip integrated circuit (IC) according to an exemplary embodiment of the present inventive concept.

The display chip IC according to an exemplary embodiment of the present inventive concept may include a display driver circuit DDI and a touch circuit TC. The display chip IC receives image data from an external host and receives receiving signals from a touch screen panel. The display driving circuit DDI processes the image data, generates gray scale data for driving a display device, and provides the generated gray scale data to a display panel. The touch circuit TC generates differential signals among the receiving signals, obtains touch data based on the generated differential signals, determines a position of a point in which a touch is generated based on the touch data, and provides the position to the external host. At this time, the touch circuit TC may correspond to the touch circuit described in FIG. 1. The display driving circuit DDI and the touch circuit TC transmit/receive a command signal and a timing signal to/from each other, and may complementarily operate.

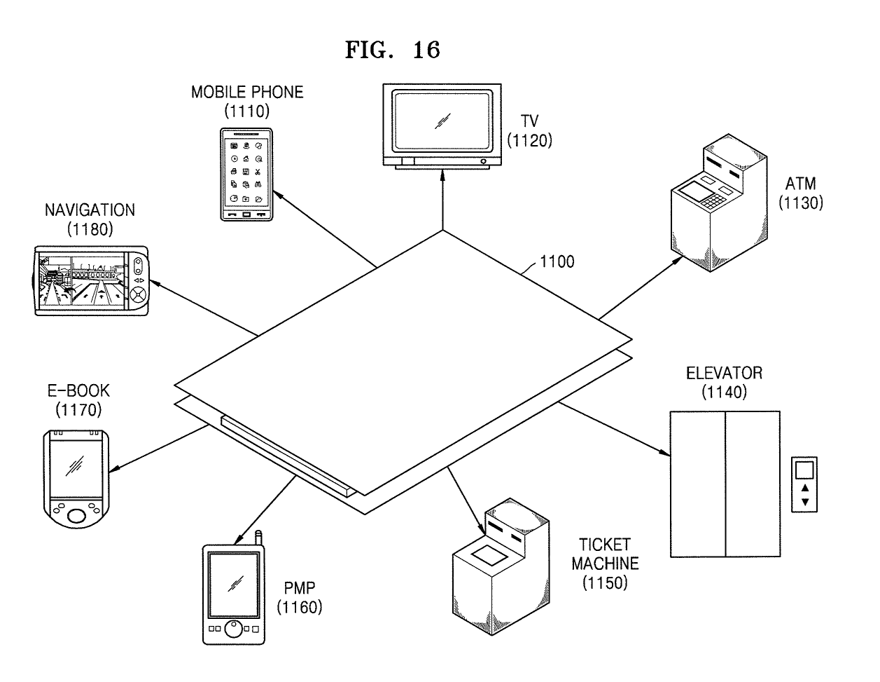

FIG. 16 is a view illustrating exemplary applications of various products in each of which a touch sensing system 1100 is mounted according to an exemplary embodiment of the present inventive concept.

Touch screen type products are widely used in various fields. Thus, touch sensitivity may necessarily be increased for precise touch sensing. Therefore, the touch sensing system 1100 according to an exemplary embodiment of the present inventive concept may be used for a TV 1120 adopting a touch screen panel, an automated teller machine (ATM) 1130 that automatically performs cash-based businesses of a bank, an elevator 1140, a ticket machine 1150 used in a subway, a portable multimedia player (PMP) 1160, an e-book 1170, a navigator 1180, a mobile phone 1110, or the like. The touch sensing system 1100 may be used for all the fields in which user interface is required.

While the present inventive concept has been particularly shown and described with reference to exemplary embodiments thereof, it will be understood that various changes in form and details may be made therein without departing from the spirit and scope of the present inventive concept as defined by the following claims.

What is claimed is:

1. A touch sensing device, comprising:
a touch panel configured to generate a first receiving signal, a second receiving signal, and a third receiving signal corresponding to a touch occurring at the touch sensing device;
a receiving unit connected to the touch panel through a first receiving line, a second receiving line, and a third receiving line, wherein the receiving unit receives the first receiving signal, the second receiving signal, and the third receiving signal through the first receiving line, the second receiving line, and the third receiving line, respectively,
wherein the receiving unit further comprises a differential signal generator,
wherein the differential signal generator is configured to exclude a first common signal common to the first receiving signal and the second receiving signal from each of the first receiving signal and the second receiving signal to generate first differential signals when a first touch sensing operation is performed,
wherein the differential signal generator is configured to exclude a second common signal common to the second receiving signal and the third receiving signal from each of the second receiving signal and the third receiving signal to generate second differential signals when a second touch sensing operation is performed.

2. The touch sensing device of claim 1, wherein the first and second differential signals comprise a first noise component caused by a voltage applied to a display panel adjacent to the touch panel, and
wherein the receiving unit further comprises a charge integrator,
wherein the charge integrator includes:
a demodulator configured to convert the first noise component into a second noise component having a higher frequency than that of the first noise component; and
a charge amplifier including a low pass filter to filter the second frequency noise component.

3. The touch sensing device of claim 2, wherein the demodulator is configured to convert the first and second differential signals excluding the first noise components into direct current (DC) component signals having a uniform level, and
wherein the charge amplifier is configured to integrate charges corresponding to the DC component signals.

4. The touch sensing device of claim 1, wherein the differential signal generator comprises:
a first node and a second node to which input voltages corresponding to the first through third receiving signals are selectively applied; and
a common mode amplifier to which a common voltage for excluding one of the first common signal or the second common signal is applied.

5. The touch sensing device of claim 4, wherein the differential signal generator comprises a switching block including a plurality of switching units for selectively connecting two receiving lines among the first receiving line, the second receiving line, and the third receiving line to the common mode amplifier.

6. The touch sensing device of claim 4, wherein the common mode amplifier is configured to convert the input voltages into the common voltage and to maintain the common voltage.

7. The touch sensing device of claim 4, wherein the common voltage is a voltage having a uniform level in a mutual capacitance sensing mode and is a voltage having a square pulse shape in a self-capacitance sensing mode.

8. The touch sensing device of claim 4, wherein the common mode amplifier comprises:
an input unit for selectively providing a current to an amplifying unit based on information on magnitudes of the input voltages and the common voltage,
an amplifying unit for amplifying the current provided from the input unit; and
an output unit for outputting an output signal for excluding one of the first common signal or the second common signal.

9. A touch sensing system for driving a touch panel, comprising:
a transmitting unit connected to driving lines in the touch panel to provide driving signals;
a receiving unit including a differential signal generator connected to receiving lines in the touch panel to respectively receive receiving signals generated by the driving signals, wherein the receiving unit is configured to generate differential signals among the receiving signals; and
a touch sensing controller configured to control a timing of the driving signals and a generation of the differential signals.

10. The touch sensing system of claim 9, wherein the touch sensing controller is configured to control the transmitting unit to sequentially provide the driving signals to the driving lines and to control the generation of the differential signals when a touch sensing operation for a first driving line among the driving lines is performed, and
wherein each of the differential signals is generated by pairing two receiving signals of the receiving signals.

11. The touch sensing system of claim 9, wherein the differential signal generator comprises:
a common mode amplifier configured to exclude a common signal common to two receiving signals of the receiving signals from each of the two receiving signals; and
a switching block including a plurality of switching units for selectively connecting the receiving lines to the common mode amplifier, and
wherein the touch sensing controller controls the switching block to connect a first receiving line and a second receiving line of the receiving lines to the common mode amplifier in a first touch sensing period of a touch sensing period.

12. The touch sensing system of claim 11, wherein the touch sensing controller controls the switching block to connect the second receiving line and a third receiving line of the receiving lines to the common mode amplifier in a second touch sensing period of the touch sensing period.

13. The touch sensing system of claim 12, further comprising a charge integrator for integrating charges corresponding to the differential signals,
wherein the touch sensing controller resets the charges integrated by the charge integrator during the first touch sensing period when the first touch sensing period ends and resets the charges integrated by the charge integrator in the second touch sensing period when the second touch sensing period ends.

14. The touch sensing system of claim 11, wherein the switching block comprises at least one multiplexer having an input and output ratio of (N+1):N (N is a natural number).

15. The touch sensing system of claim 9,
wherein the differential signal generator comprises a plurality of common mode amplifiers each including a first terminal and a second terminal connected to two receiving lines among the receiving lines, and
wherein a common voltage for excluding a common signal common to the two receiving signals from each of the two receiving signals received from the two receiving lines is applied to the common mode amplifier.

16. A touch sensing system for driving a touch panel, comprising:
a transmitting unit for providing first signals to the touch panel; and
a receiving unit for receiving second signals generated by the touch panel in response to the first signals,
wherein the receiving unit includes a differential signal generator configured to generate a first differential signal from a first pair of the second signals.

17. The touch sensing system of claim 16, wherein the differential signal generator is configured to output a signal generated by excluding a common signal common to the first pair of the second signals from each of the first pair of the second signals as the first differential signal.

18. The touch sensing system of claim 16, wherein the differential signal generator comprises:
a first node and a second node to which input voltages corresponding to the second signals are selectively applied; and
a common mode amplifier to which a common voltage for excluding the common signal is applied.

19. The touch sensing system of claim 18, wherein the common mode amplifier comprises:
an input unit for selectively providing a current to an amplifying unit based on information on magnitudes of the input voltages and the common voltage,
an amplifying unit for amplifying the current provided from the input unit; and
an output unit for outputting an output signal for excluding the common signal.

20. The touching sensing system of claim 16, wherein the differential signal generator generates a second differential signal from a second pair of the second signals.
